(19) United States
(12) Patent Application Publication
(10) Pub. No.: US 2003/0021889 A1
(43) Pub. Date: Jan. 30, 2003

(54) Method for manufacturing multilayer circuit board

(76) Inventor: Yasuhiro Wakizaka, Kawasaki-shi (JP)

Correspondence Address: BIRCH STEWART KOLASCH & BIRCH, PO BOX 747, FALLS CHURCH, VA, 22040-0747, US

(21) Appl. No.: 10/182,816

(22) PCT Filed: Feb. 1, 2001
(86) PCT No.: PCT/JP01/00688

(30) Foreign Application Priority Data
Feb. 3, 2000 (JP) 2000-26870

(51) Int. Cl. B05D 5/12

(52) U.S. Cl. 427/98; 427/96

(57) ABSTRACT

A method for manufacturing a multilayer circuit board, in which adhesion between electrical insulating layer and a conductive layer is high and the patternability is also excellent, is provided. The method for manufacturing the multilayer circuit board comprises a step of; 1) bringing the surface of the electrical insulating layer produced by setting a setting resin composition containing an alicyclic olefin polymer or an aromatic polyether polymer into contact with a permanganic acid compound or a plasma, 2) dry-plating the surface and then wet- or dry-plating the surface, 3) dry-plating the surface several times and then wet-plating the surface, or 4) plating the surface and then annealing it, so as to form a conductive layer.

### TECHNICAL FIELD

The present invention relates to a method for manufacturing a multilayer circuit board, and more particularly to a method for manufacturing a multilayer circuit board in which adhesion between an electrically insulating layer and a conductive layer is high and the patternability is also excellent.

### BACKGROUND ART

As electronic apparatuses have become small-sized and multi-functional, a high density is increasingly required for circuit boards used in these electronic apparatuses.

A general approach to a higher density circuit board is to manufacture a multilayer circuit board, as is well known to those skilled in the art. A multilayer circuit board is usually obtained by first preparing an internal layer circuit board that consists of an electrically insulating layer (1) and a conductor circuit (1) formed thereon, and by stacking an electrically insulating layer (2) on the internal layer circuit board and forming another conductor circuit (2) on the electrically insulating layer (2), and by further stacking, as required, a desired number of repetitions of an electrically insulating layer and a conductive circuit.

The conductive circuit in a multilayer circuit board is formed by covering the entire surface of the electrically insulating layer with a conductor such as Cu using, for example, a wet plating technique, a dry plating technique, or the like, and by forming, as required, a desired circuit pattern by means of an etching process using a photoresist or the like.

As is well known to those with ordinary skill in the art, in order to improve adhesion between the electrically insulating layer and the conductor formed by plating, the surface roughness of the electrically insulating layer is increased. However, the conductive layer provided on the electrically insulating layer which has increased surface roughness becomes poorer in patternability. As a result, a desired impedance or conductance cannot be easily realized and the circuit tends to pick up more noise, On the other hand, when surface roughness is small, adhesion between the electrically insulating layer and the conductor becomes poor.

It is therefore an object of the present invention to provide a multilayer circuit board in which adhesion between an electrically insulating layer and a conductive layer is high and patternability is also excellent.

As a result of intensive study conducted by the present inventor, it has been found that above object can be attained by using an electrically insulating layer produced by setting a setting resin composition containing an alicyclic olefin polymer or an aromatic polyether polymer, and by treating the surface of the insulating layer by:

1) bringing the surface into contact with a permanganic acid compound or a plasma, and then dry plating the surface;

2) dry-plating the surface, and then wet- or dry-plating the surface;

3) dry-plating the surface several times, and then wet-plating it; or

4) plating it and then annealing it. The present invention has been completed based on the finding as described above.

### DISCLOSURE OF INVENTION

Thus, according to the present invention, there are provided (1) a method for manufacturing a multilayer circuit board comprising the step of bringing the surface of the electrically insulating layer produced by setting a setting resin composition containing an alicyclic olefin polymer or an aromatic polyether polymer into contact with a permanganic acid compound or a plasma and then dry-plating the surface, (2) a method for manufacturing a multilayer circuit board comprising the step of dry-plating the surface of the electrically insulating layer produced by setting a setting resin composition containing an alicyclic olefin polymer or an aromatic polyether polymer and then wet- or dry-plating the surface, (3) a method for manufacturing a multilayer circuit board comprising the step of dry-plating the surface of the electrically insulating layer produced by setting a setting resin composition containing an alicyclic olefin polymer or an aromatic polyether polymer several times and then wet-plating it, (4) a method for manufacturing a multilayer circuit board comprising the step of bringing the surface of the electrically insulating layer produced by setting a setting resin composition containing an alicyclic olefin polymer or an aromatic polyether polymer into contact with a permanganic acid compound or a plasma, dry-plating the surface, and then wet- or dry-plating the surface, and (5) a method for manufacturing a multilayer circuit board according to any one of (1)-(4) above, comprising the step of plating and then annealing.

### BEST MODE FOR CARRYING OUT THE INVENTION

The method for manufacturing a multilayer circuit board according to the present invention comprises the step of treating the surface of the electrically insulating layer (2) produced by setting a setting resin composition containing an alicyclic olefin polymer or an aromatic polyether polymer using one of the methods described below.

The electrically insulating layer (2) used in the present invention is produced by setting a setting resin composition containing an alicyclic olefin polymer or an aromatic polyether polymer, preferably an alicyclic olefin polymer.

The alicyclic olefin polymer that consitutes the composition is an olefin polymer having alicyclic structure. The alicyclic structure includes a cycloalkane structure and a cycloalkene structure and preferably a cycloalkane structure in view of the mechanical strength, thermal resistance, and the like. The alicyclic structure includes monocyclic and polycyclic structures (condensation polycyclic, cross linking polycyclic structyres, or combination thereof). Although the number of carbon atoms composing the monocyclic structure is not specially limited, the compound is advantageous when number of carbon atoms is typically in the range 4˜30, preferably 5˜20, more preferably 5˜15, since it is well balanced in various properties such as mechanical strength, thermal resistance and moldability. The alicyclic olefin polymer used in the present invention is usually thermoplastic.

An alicyclic olefin polymer usually contains repeating unit derived from an olefin having alicyclic structure (hereinafter referred to as an alicyclic olefin). The proportion of the repeating units derived from alicyclic olefin in the alicyclic olefin polymer may be suitably chosen depending upon the object of use, but it is typically in the range 30˜100 wt %, preferably in the range 50˜100 wt %, and more preferably in the range 70˜100 wt %. If the proportion of repeating units derived from alicyclic olefin is excessively small, the polymer may exhibit poor thermal resistance.

The alicyclic olefin polymer used in the present invention preferably has polar groups. The polar groups include a hydroxyl group, a carboxyl group, an alkoxyl group, an epoxy group, a glycydyl group, an oxycarbonyl group, a carbonyl group, an amino group, an ester group, and a carboxylic acid anhydride group and, preferably, a carboxyl group or a carboxylic acid anhydride group.

The alicyclic olefin polymer is usually obtained by addition polymerization or ring-opening polymerization of alicyclic olefin and hydrogenation of unsaturated bond as necessary, or by addition polymerization of aromatic olefinand by hydrogenation of the aromatic ring of the polymer. The alicyclic olefin polymer having polar group is obtained by, for example, 1) introducing a compound having polar group into above alicyclic olefin polymer by denaturation reaction, 2) copolymerization of monomer having polar group as a copolymerization component, or 3) copolymerization of monomer having polar group such as ester group as a copolymerization component and hydrolysis of the ester group.

Alicyclic olefins useful to obtain an alicyclic olefin polymer includes norbornene type monomer such as bicyclo [2.2.1]-hepto-2-ene (customary name: norbornene), 5-methyl-bicyclo-[2.2.1]-hepto-2-ene, 5,5-dimethyl-bicyclo-[2.2.1]-hepto-2-ene, 5-ethyl-bicyclo [2.2.1]-hepto-2-ene, 5-buthyl-bicyclo [2.2.1]-hepto-2-ene, 5-hexyl-bicyclo [2.2.1]-hepto-2-ene, 5-octyl-bicyclo [2.2.1]hepto-2-ene, 5-octadecyl-bicyclo [2.2.1]-hepto-2-ene, 5-ethylidene-bicyclo [2.2.1]-hepto-2-ene, 5-methylidene-bicyclo [2.2.1]-hepto-2-ene, 5-vinyl-bicyclo [2.2.1]-hepto-2-ene, 5-propenyl-bicyclo [2.2.1]-hepto-2-ene, 5-methoxycarbonyl-bicyclo[2.2.1]-hepto-2-ene, 5-ethoxycarbonyl-bicyclo [2.2.1]-hepto-2-ene, bicyclo [2.2.1]-hepto-5-enyl-2-methylpropionate, bicyclo [2.2.1]-hepto-5-enyl-2-methyloctanate, bicyclo [2.2.1]-hepto-2-ene-5,6-dicarboxylic acid anhydride, 5-hydroxymethylbicyclo-[2.2.1]-hepto-2-ene, 5,6-di(hydroxymethyl)-bicyclo [2.2.1]-hepto-2-ene, 5-hydroxy-i-propylbicyclo-[2.2.1]-hepto-2-ene, 5,6-dicarboxy-bicyclo[2.2.1]-hepto-2-ene, bicyclo[2.2.1]-hepto-2-ene-5,6-dicarboxylic acid imide, 5-cyclopentyl-bicyclo [2.2.1]-hepto-2-ene, 5-cyclohexenyl-bicyclo[2.2.1]-hepto-2-ene, 5-phenyl-bicyclo [2.2.1]-hepto-2-ene, tricyclo [4.3.0.1^{2, 5}]deca-3,7-diene (customary name; dicyclopentadiene), tricyclo[4.3.0.1^{2, 5}]deca-3-ene, tricyclo [4.4.0.1^{2, 5}]undeca-3,7-diene, tricyclo[4.4.0.1^{2, 5}]undeca-3,8-diene, tricyclo [4.4.0.1^{2, 5}]undeca-3-ene, tetracyclo [7.4.0.1^{10, 13}.0^{2, 7} ]-trideca-2,4,6-11-tetraene (alias: 1,4-methano-1,4,4a,9a-tetrahydrofluorene), tetracyclo [8.4.0.1^{11, 14}.0^{3, 8}]-tetradeca-3,5,7,12-11-tetraene (alias: 1,4-methano-1,4,4a,5,10,10a-hexahydroanthracene), tetracyclo [4.4.0.1^{2, 5}.1^{7, 10}]-dodeca-3-ene (customary name: tetracyclododecene), 8-methyl-tetracyclo-[4.4.0.1^{2, 5}.1^{7, 10}]-dodeca-3-ene, 8-ethyl-tetracyclo-[4.4.0.1^{2, 5}.1^{7, 10}]-dodeca-3-ene, 8-methylidene-tetracyclo-[4.4.0.1^{2, 5}.1^{7, 10}]-dodeca-3-ene, 8-ethylidene-tetracyclo-[4.4.0.1^{2, 5}.1^{7, 10}]-dodeca-3-ene, 8-vinyl-tetracyclo-[4.4.0.1^{2, 5}.1^{7, 10}]-dodeca-3-ene, 8-propenyl-tetracyclo-[4.4.0.1^{2, 5}.1^{7, 10}]-dodeca-3-ene, 8-methoxycarbonyl-tetracyclo-[4.4.0.1^{2, 5}.1^{7, 10}]-dodeca-3-ene, 8-methyl-8-methoxycarbonyl-tetracyclo-[4.4.0.1^{2, 5}.1^{7, 10}]-dodeca-3-ene, 8-hydroxymethyl-tetracyclo-[4.4.0.1^{2, 5}.1^{7, 10}]-dodeca-3-ene, 8-carboxy-tetracyclo-[4.4.0.1^{2, 5}.1^{7, 10}]-dodeca-3-ene, 8-cyclopentyl-tetracyclo-[4.4.0.1^{2, 5}.1^{7, 10}]-dodeca-3-ene, 8-cyclohexyl-tetracyclo-[4.4.0.1^{2, 5}.1^{7, 10}]-dodeca-3-ene, 8-cyclohexenyl-tetracyclo-[4.4.0.1^{2, 5}.1^{7, 10}]-dodeca-3-ene, 8-phenyl-tetracyclo-[4.4.0.1^{2, 5}.1^{7, 10}]-dodeca-3-ene, pentacyclo [6.5.1.1^{3, 6}.0^{2, 7}.0^{9, 13}]pentadeca-3,10-diene, pentacyclo [7.4.0.1^{3, 6}.1^{10, 13}.0^{2, 7}]pentadeca-4,11-diene, tetracyclo [6.5.0.1^{2, 5}.0^{8, 13}]trideca-3,8,10,12-tetraene, tetracyclo [6.6.0.1^{2, 5}.1^{8, 13}]tetradeca-3,8,10,12-tetraene; monocyclic cycloalkene such as cyclobutene, cyclopentene, cyclohexene, 3,4-dimethylcyclopentene, 3-methylcyclohexene, 2-(2-methylbutyl)-1-cyclohexene, cyclooctene, 3a,5,6,7a-tetrahydro-4,7-methano-1H-indene, cycloheptene; vinyl alicyclic hydrocarbon monomer such as vinylcyclohexene and vinylcyclohexane; alicyclic diene monomer such as cyclopentadiene, cyclohexadiene. Aromatic olefin compounds include styrene, α-methylstyrene, divinyl benzene, etc. Alicyclic olefin and/or aromatic olefin compounds may be used alone, or in combination of two or more thereof.

The alicyclic olefin polymer may be produced by copolymerization of above described alicyclic olefin and/or aromatic olefin compounds and a monomer copolymerizable with these compounds.

Monomers that can be copolymerized with alicyclic olefin or aromatic olefin compounds include, ethylene or α-olefin with carbon number 2˜20, such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4-4-dimethyl-1-hexene, 4-4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicocene; diene such as 1,4-hexadiene, 4-methyl-1,4-hexadiene, 5-methyl-1,4-hexadiene, 1,7-octadiene. These monomers may be used alone or in combination of two or more thereof. In ring-opening polymerization, these monomers may act as an agent for adjusting molecular weight.

There is no special limitation as to the method of polymerization of alicyclic olefin and/or aromatic olefin compounds nor to the method of hydrogenation performed as necessary, and any method known to those with ordinary skill in the art may be employed.

Specific examples of the alicyclic olefin polymers include open-ring polymers of norbornene type monomers and their hydrides, addition polymers of norbornene type monomers, addition polymers of norbornene type monomers and vinyl compounds, monocyclic cycloalkene polymers, alicyclic conjugate diene polymers, vinyl alicyclic hydrocarbon polymers and their hydrides, aromatic ring hydrides of aromatic olefin polymers. Among them, the polymer used in the present invention is preferably open-ring polymers of norbornene type monomers and their hydrides, addition polymers of norbornene type monomers, addition polymers of norbornene type monomers and vinyl compounds, and aromatic ring hydrides of aromatic olefin polymers, and particularly preferably hydrides of open-ring polymers of norbornene type monomers.

The above described alicyclic olefin polymers may be used alone or in combination of two or more thereof.

The alicyclic olefin polymer is not particularly limited as to its molecular weight. Molecular weight of an alicyclic olefin polymer is typically in the range 1,000˜1,000,000, preferably 5,000˜500,000, and more preferably 10,000˜250,000, in polystyrene equivalent weight-average molecular weight (Mw) as measured by gel permeation chromatography (GPC) using cyclohexane or toluene as a solvent. The alicyclic olefin polymer has well-balanced and advantageous properties in terms of thermal resistance and smoothness of the mold surface when its weight average molecular weight (Mw) is in the above range. Molecular weight distribution of alicyclic olefin polymers is, when expressed as ratio (Mw/Mn) of weight-average molecular weight (Mw) as measured by GPC using cyclohexane or toluene as a solvent to number-average molecular weight (Mn), typically 5 or less, preferably 4 or less, and more preferably 3 or less. The range and measuring method of weigh-average molecular weight (Mw) and molecular weight distribution (Mw/Mn) as described above may be applied advantageously to norbornene type polymers, but are not limited to these polymers. Even when weigh-average molecular weight and molecular weight distribution of an alicyclic olefin polymer cannot be measured with the above method, the polymer having melt viscosity and degree of polymerization such that resin layer can be formed by ordinary processing of the melt may be used in the present invention.

Glass transition temperature of the alicyclic olefin polymer may be suitably chosen depending upon the object of use and is typically 50° C. or higher, preferably 70° C. or higher, more preferably 100° C. or higher, and most preferably 125° C. or higher.

An aromatic polyether polymer forming the setting resin composition is polyether having aromatic rings, and can be obtained by reacting 2,6-disubstituted phenols such as 2,6-dimethyl phenol or 2,6-diphenylphenol with oxygen under the presence of basic copper (II) salt such as copper (II) amine complex. Aromatic polyether polymers include polyphenylene ether, denaturated polyphenylene ether, and the like. Among them, denaturated polyphenylene ether with a small dielectric constant and a small dielectric loss tangent can be used advantageously.

A setting agent may be blended to the setting resin composition used in the present invention. There is no special limitation to the setting agent, and an ionic setting agent, a radical setting agent, or a setting agent that is both ionic and radical, for example, may be used. However, in view of insulating resistance, thermal resistance, chemical resistance and mutual solubility with the alicyclic olefin polymer, an ionic setting agent is preferred. Ionic setting agents include, for example, aliphatic polyamine compounds; alicyclic polyamine compounds; aromatic polyamine compounds; bisazide compounds; carboxylic acid anhydrides; dicarboxylic acids; dior compounds; triors; polyphnols; polyamide compounds; diisocyanate compounds; polyepoxy compounds. Radical setting agents include, for example, organic peroxides. Among them, dior compounds, polyphenol compounds, and polyepoxy compounds which are solid at usual temperatures are preferred, and polyepoxy compounds which are solid at usual temperatures are particularly preferred. These setting agents may be used alone, or in combination of two or more thereof. The blending ratio is such that, relative to 100 parts by weight of the alicyclic olefin polymer or aromatic polyether polymer (hereinafter referred to as alicyclic olefin polymer etc.), typically 5˜150 parts by weight, preferably 15˜110 parts by weight, and more preferably 30˜100 parts by weight, of the setting agent is used.

In order to accelerate a setting reaction of the alicyclic olefin polymer etc. with the setting agent, a setting accelerator or a setting assistant may be used.

There is no special limitation to setting accelerators. When the setting agent is, for example, a polyepoxy compound, a tertiary amine compound, a trifluoroboron complex or the like can be advantageously used. When a tertiary amine is used, the stacking property for fine wirings, the insulating resistance, the thermal resistance and the chemical resistance are improved.

These setting accelerators may be used alone, or in combination of two or more thereof. The blending ratio can be suitably chosen depending upon the object of use, and is typically 0.001˜30 parts by weight, preferably 0.01˜10 parts by weight, and more preferably 0.03˜5 parts by weight, relative to 100 parts by weight of the alicyclic olefin polymer etc.

There is no special limitation to setting assistants. Setting assistants include, for example, oxime-nitroso type setting assistants; maleimide type setting assistants; allyl type setting assistants; methacrylate type setting assistants; vinyl setting assistants; and the like. These setting assistants may be used alone, or in combination of two or more thereof. The blending ratio is typically 1˜1000 parts by weight, preferably 10˜500 parts by weight, relative to 100 parts by weight of the setting agent.

Preferably, a liquid epoxy resin is blended with the setting resin composition used in the present invention. The liquid epoxy resin is an epoxy compound (or resin) which is solid at ordinary temperature in the absence of solvent. Specifically, the liquid epoxy resins include phenol type liquid epoxy resins such as CAS 58421-55-9, CAS 9003-85-4, CAS 30621-65-9, CAS 89118-70-7, dibromocresylglycidyl ether; amine type liquid epoxy resins such as CAS 28768-32-3, existent chemical substance 3-2792, CAS 2095-06-9, CAS 40027-50-7; alcohol type liquid epoxy resins such as CAS 34629-78-2, CAS 29611-97-0, CAS 7-343, CAS 9072-62-2, CAS 30499-70-8, CAS 30583-72-3, CAS 11121-15-6; ester type liquid epoxy resins such as CAS 27103-66-8, CAS 7195-45-1, CAS 36343-81-4, CAS 36221-25-7, CAS 68475-94-5, CAS 68991-71-9; other liquid epoxy resins such as CAS 25085-98-7, CAS 29797-71-5, CAS 25616-47-7, CAS 28825-96-9; epoxy denaturated liquid rubber (specifically, epoxy denaturated liquid polybutadiene), rubber dispersion liquid epoxy resin, bisphenol A type liquid epoxy resin, bisphenol F type liquid epoxy resin, phenol novolac type liquid epoxy resin.

These epoxy resins may be used alone or in combination of two or more thereof. The blending ratio is typically in the range of 1˜100 parts by weight, preferably 5˜80 parts by weight, and more preferably 7˜60 parts by weight, relative to 100 parts by weight of the alicyclic olefin polymers etc.

Other components may be blended as desired to the setting resin composition used in the present invention. Other components include polymers and compounding agent other than the alicyclic olefin polymer etc.

Polymers other than the alicyclic olefin polymer etc. include, for example, rubber type polymers and resins.

Rubber type polymers are polymers with a Tg typically not higher than 30° C. Specific examples of rubber type polymers include diene type rubbers such as natural rubber, polyisobutylene rubber, butyl rubber, polybutadiene rubber, polyisoprene rubber, acrylnitrile butadiene copolymer rubber, styrene butadiene copolymer rubber, styrene isoprene copolymer rubber, styrene butadiene isoprene ternary copolymer rubber, and hydrides of these diene type rubbers; saturated polyolefin rubber such as ethylene α-olefin copolymers, for example, ethylene propylene copolymers and the like, propylene other α-olefin copolymers; α-olefin diene type copolymer rubbers such as ethylene propylene diene copolymer, α-olefin diene copolymer, isobutylene isoprene copolymer, isobutylene diene copolymer; special rubbers such as urethane rubber, polyether rubber, acrylic rubber, propylene oxide rubber, ethylene acrylic rubber; styrene type thermoplastic elestomers and their hydrides such as styrene butadiene styreneblock copolymer rubber, styrene isoprene styreneblock copolymer rubber; urethane type thermoplastic elastomer; polyamide type thermoplastic elastomer; 1,2-polybutadiene thermoplastic elastomer; silicone rubber.

Resins include polyolefins such as low density polyethylene, high density polyethylene, linear chain low density polyethylene, super low density polyethylene, polypropylene, syndiotactic polypropylene, polybutene, polypentene; polyamide such as nylon 66; ethylene-ethylacrylate copolymer, ethylene-vinyl acetate copolymer; polyester; polycarbonate; acrylic resin; polyimide; silicone resin.

These polymers may be used alone or in combination of two or more thereof. Blending ratio of the other polymers is typically 100 parts by weight or less, preferably 70 parts by weight or less, and more preferably 50 parts by weight or less, with a lower limit of 0 part by weight, relative to 100 parts by weight of alicyclic olefin polymers etc.

Compounding agents include fillers, flame retardants, flame retardant assistants, thermal resistant stabilizers, weather resistance stabilizers, leveling agents, antistatic agents, slipping agents, anti-blocking agents, anti-clouding agents, lubricants, dyes, pigments, natural oil, synthetic oil, wax, emulsifying agents. The blending ratio is suitably chosen within the range such that the attainment of the object of the present invention is not obstructed.

In order to improve insulating resistance and peeling resistance, compounding agents preferably include thiol compounds, preferably plyhydric thiol compounds having at least two thiol group in the molecule, and more preferably those having a heterocyclic structure in the molecule. Triazine ring structure is preferred for the heterocyclic structure. A trizine thiol compound is preferred when embedding of wirings is further taken into account. The blending ratio of the thiol compound is typically in the range 0.001˜30 parts by weight, preferably 0.01˜10 parts by weight, relative to 100 parts by weight Of the alicyclic olefin polymer etc. If the blending ratio is too small, little effect can be obtained on insulating resistance and peeling resistance, and if the blending ratio is too large, thermal resistance and chemical resistance tend to be deteriorated.

The electrically insulating layer (2) is usually formed on an internal layer circuit board. The internal layer circuit board consists of an electrically insulating layer (1) and a conductor circuit layer (1) formed thereon.

The conductor circuit layer (1) forming the internal layer circuit board is an electric circuit formed by conductors such as conductive metals, and the same circuit construction as used in ordinary multilayer circuit boards may be used.

Specific examples of the internal layer circuit board include printed circuit boards, silicon wafer substrates, and the like. The thickness of the internal layer circuit board is typically 50 μm˜2 mm, preferably 60 μm˜1.6 mm, and more preferably 100 μm˜1 mm.

There is no special limitation to the material for the electrically insulating layer (1) forming the internal layer circuit board as long as it is electrically insulating. Materials useful for the electrically insulating layer (1) include, for example, those produced by setting a setting composition containing alicyclic olefin polymers, epoxy resins, maleimide resins, (meth)acrylate resins, diallyl phthalate resins, triazine resins, polyphenylene ether. The internal layer circuit board may contain glass fiber, aramid fiber or the like to increase strength.

Method generally used for forming an electrically insulating layer (2) on the internal circuit board is to form a coated layer of setting composition by coating solution or dispersed phase of above mentioned setting composition and by drying and removing the solvent, and then to set the composition. However, in the present invention, it is preferable to form the electrically insulating layer (2) by forming a film or a sheet of the setting resin composition, overlaying and pressing the sheet or the film onto the internal layer circuit board under heat and pressure, and then setting the sheet or the film.

There is no special limitation to the method for forming the setting resin composition into a sheet or a film. In the present invention, a solution casting method or melt casting method is preferable for forming a sheet or a film. In solution casting method, solution or dispersed phase of above mentioned setting composition is coated to a support, and the solvent is removed by drying.

Solvents useful for dissolving or dispersing the setting resin composition of the present invention include, for example, aromatic hydrocarbon type solvents such as toluene, xylene, ethylbenzene, trimethylbenzene; aliphatic hydrocarbon type solvent such as n-pentane, n-hexane, n-heptane; alicyclic hydrocarbon type solvents such as cyclopentane, cyclohexane; halogenated hydrocarbon type solvents such as chlorobenzene, dichlorobenzene, trichlorobenzene; ketone type solvents such as methylethyl ketone, methylisobutyl ketone, cyclopentanone, cyclohexanone. These solvents may be used alone or in combination of two or more thereof.

Among these solvents, a mixed solvent in which a non-polar solvent such as an aromatic hydrocarbon type solvent or an alicyclic hydrocarbon type solvent is mixed with a polar solvent such as a ketone type solvent is preferred since it exhibits excellent embedding property for fine wirings and does not give rise to air bubbles. The mixing ratio of the non-polar solvent and a polar solvent may be suitably chosen, and is typically 5:95˜95:5, preferably 10:90˜90:10, and more preferably 20:80˜80:20.

Such solvents may be suitably chosen depending upon the use. Solvents may be used in an amount such that the solid concentration of the setting resin composition in the solution or the dispersion is typically 5˜70% by weight, preferably 10˜65% by weight, and more preferably 20˜60%.

A usual method may be employed for dissolving or dispersing the setting resin composition into the solvent, including, for example, mixing with a mixer and magnetic stirrer, a high speed homogenizer, dispersion, a planetary mixer, a biaxial mixer, a ball mill, three-roll mixer, and the like.

Supports used for solution casting method include resin films or metal foils. Resin films used in the invention is typically thermoplastic resin films, including specifically, polyethylene terephthalate film, polypropylene film, polyethylene film, polycarbonate film, polyethylene naphthalate film, polyarylate film, nylon film, and the like. Among these resin films, polyethylene terephthalate film, polyethylene naphthalate film or the like, is preferred in view of thermal resistance, chemical resistance and peeling after lamination. Metal foils useful in the invention include, for example, copper foil, aluminum foil, nickel foil, chrome foil, gold foil, silver foil, and the like. Copper foil, in particular, electrolytic copper foil and rolled copper foil, may be advantageously used in view of good conductivity and low cost. Thickness of the support is not particularly limited, but in view of workability, is typically 1˜150 μm, preferably 2˜100 μm, and more preferably 3˜50 μm.

Methods of coating include dip coating, roll coating, curtain coating, die coating, slit coating, and the like. Condition for drying and removing solvents may be suitably chosen depending upon the type of solvents used. Drying temperature is typically 20˜300° C., preferably 30˜200° C., and drying time is typically 30 seconds˜1 hour, preferably 1˜30 minutes.

The thickness of the film or sheet is typically in the range of 0.1˜150 μm, preferably 0.5˜100 μm, and more preferably 1˜80 μm. When it is desired to obtain a film or sheet free from the support, after forming the film or sheet on the support, it is separated from the support.

In order to laminate a film or sheet formed of a setting resin composition on the internal layer circuit board, the film or sheet is usually overlaid together with the support onto the internal layer circuit board so as to bring the film or sheet into contact with the surface of the internal layer circuit board, and is hot-pressed under heat and pressure using a pressing machine such as a pressure laminator, a press, a vacuum laminator, a vacuum press, a roll laminator or the like. This hot-pressing under heat and pressure is preferably performed in vacuum in order to obtain improved the embedding property for wirings and to suppress generation of air bubbles. During the hot-pressing, the temperature is typically in the range 30˜250° C., preferably 70˜200° C., and pressure is typically in the range 0.1˜200 Kg/cm², preferably 1˜100 Kg/cm², and pressing time is typically 30 seconds˜5 hours, preferably 1 minute˜3 hours, and atmospheric pressure is preferably reduced to 300 mmHg˜0.1 mmHg.

In order to set a setting resin composition, usually heat is applied to the setting resin composition. Setting temperature may be suitably selected depending upon the type of setting agent used, and is typically in the range 30˜400° C., preferably 70˜300° C., and more preferably 100˜200° C., and setting time is typically 0.1˜5 hours, and preferably 0.5˜3 hours. When the film or sheet together with the support is laminated onto the setting resin composition, the film or sheet formed of the setting resin composition may be heated and set with the support attached thereon, but usually the film or sheet formed of the setting resin composition is heated and set after the support is separated therefrom.

The manufacturing method of the present invention comprises the step of 1) bringing the surface of the above described electrically insulating layer (2) into contact with a permanganic acid compound or a plasma, and then dry-plating it, 2) dry-plating the surface, and then wet- or dry-plating the surface, or 3) dry-plating the surface several times and then wet-plating it.

The permanganic acid compounds used in the present invention include, for example, potassium permanganate, permanganic aid, sodium permanganate, and the like- The permanganic acid compound is usually dissolved in water and then brought into contact with the surface of the electrically insulating layer. The concentration of the aqueous solution of the permanganic acid compound is typically 0.001˜5 mol/l, 0.005˜3 mol/l.

When the permanganic acid is brought into contact with the electrically insulating layer, the temperature of the aqueous solution is typically in the range 10˜100° C., preferably 40˜90° C., and the contacting time is typically in the range 0.1˜120 minutes, preferably 1˜60 minutes. There is no special limitation to the methods of bringing the permanganic acid into contact, and methods such as brush coating method, dip coating method, spray method, may be used.

A plasma is a highly ionized gas such as the gas between the electrodes of an arc discharge, gas in the light emitting portion in a discharge tube, corona, etc. Gases for generating the plasma include neon, argon, krypton, xenon, hydrogen, oxygen, nitrogen, tetrafluorocarbon, trifluoromethane, tetrachlorocarbon. There is no special limitation for contacting time with a plasma, and the contacting time is typically in the range 1 second˜30 minutes, preferably 10 seconds˜10 minutes.

The effect of the present invention is obtained by contact either with a permanganic aid compound or with a plasma. The effect of the present invention more clearly manifests itself when the electrically insulating layer is first brought into contact with a permanganic acid compound and then brought into contact with a plasma.

Dry-plating methods include physical vapor deposition (PVD) methods such as vacuum vapor deposition, ion plating, sputtering, molecular beam epitaxy, ion implantation, ion beam mixing; chemical vapor deposition methods such as thermal CVD, plasma CVD, photo CVD. Among these methods, physical vapor deposition method, in particular, sputtering is preferred.

The basic construction of the sputtering method is such that, in a vacuum chamber such as a discharge tube, a mother material (the material to be formed into conductive layer) called a target is connected as a cathode in direct current or capacitance connection with a high frequency power source, and the electrically insulating layer to which conductive layer is to be deposited is provided opposingly to the cathode for depositing the mother material to the electrically insulating layer as a thin film.

Methods of sputtering include direct current diode sputtering, high frequency sputtering, magnetron sputtering, opposing target sputtering, ECR sputtering, bias sputtering, plasma controlled sputtering, multi-target sputtering, etc. Among these methods, direct current diode sputtering or high frequency sputtering is preferred.

The electric power supplied in sputtering is typically 100 W or more, preferably 600 W or more, and more preferably 1100 W or more. By increasing the power of sputtering, adhesion of the deposited film can be improved.

A conductor layer is formed on the surface of the electrically insulating layer (2) by dry-plating. Conductor layers formed by dry-plating include those formed with conductive metals such as nickel, copper, aluminum, gold, silver, chromium.

Dry-plating is performed once or plural times. When plural times of dry-plating are performed repeatedly to obtain conductive layer of the same film thickness, adhesion between the conductive layer and the electrically insulating layer is improved compared to the case where dry-plating is performed only once.

The total thickness of the conductive layer formed by dry-plating is typically in the range 0.01˜50 μm, preferably 0.05˜20 μm, and more preferably 0.2˜10 μm. When dry-plating is repeatedly performed, usually, a conductive layer having thickness obtained by equally dividing the desired total thickness is preferably formed by dry-plating each time. When dry-plating is repeatedly performed, the thickness of conductive layer formed by dry-plating for one time is typically 0.001˜10 μm, and preferably 0.01˜5 μm.

Conductor layer may be obtained only by dry-plating. However, in the manufacturing method of the present invention, it is preferred to perform dry-plating and then wet-plating in order to improve adhesion between the conductive layer and the electrically insulating layer wet-plating methods include electroplating, non-electrolytic plating and melt plating.

Conductor layer is further deposited by wet-plating on the conductive layer formed by dry-plating. Conductive layers formed by wet-plating include those formed of metals such as nickel, copper, aluminum, gold, silver, chromium. It is preferable to perform wet-plating with the same metal as the conductive layer formed by dry-plating.

The thickness of a conductive layer formed by wet-plating is typically in the range 5˜50 μm, preferably 10˜30 μm.

The thickness of a conductive layer formed by dry-plating relative to thickness of conductive layer formed by wet-plating is typically 0.01˜50%, preferably 0.05˜10%. When the thickness of conductive layer formed by dry-plating is insufficient, during wet-plating performed after dry-plating, a plating solution used in wet-plating may give rise to defects in the conductive layer formed by dry-plating, and width of patterns tends to become uneven. When the conductive layer formed by dry-plating is too thick, cracks tend to be produced in the pattern.

Total thickness of conductive layer formed by dry-plating followed by wet-plating is typically in the range of about 5˜about 52 μm, preferably about 10˜about 31 μm.

A preferred manufacturing method of the present invention comprises the step of annealing after plating as described above.

Annealing is performed for reconstructing the structure of the conductive layer formed by plating. A temperature for annealing may be suitably selected depending upon the type of conductor forming the conductive layer, and is typically in the range of 20˜250° C., preferably 100˜200° C. The annealing time is typically 1˜60 minutes.

The circuit board obtained by the manufacturing method of the present invention may be used as a new internal layer circuit board, and new electrically insulating layers and conductor circuits can be stacked upon it repeatedly for several layers.

The multilayer circuit board obtained by manufacturing method of the present invention is typically used with via-holes connecting the conductor circuits which are separated by electrically insulating layers. Via-holes can be formed by physical processing such as by a drill or a laser, or by so-called photolithographic processing in which aforementioned setting resin composition is masked and set by exposure to light and an unset portion is removed. Among these methods for forming via-holes, the method using a laser such as a carbon dioxide laser, an excimer laser, a UV-YAG laser, etc. is preferred since it does not deteriorate the characteristics of insulating layers and permits finer via-holes to be formed.

In the aforementioned multilayer circuit board, a part of the conductor circuits may act as a metal power source layer, a metal grounding layer, or a metal shielding layer.

The present invention will now be described more specifically with reference to Examples and Comparative examples. In the Examples, the term “parts” refers to “parts by weight” unless otherwise specified.

Evaluation and Measurement Method

(1) Molecular weight was measured, unless otherwise specified, as a polystyrene equivalent value by gel permeation chromatography (GPC) using toluene as solvent.

(2) Hydrogenation ratio and carboxyl group content were measured by ¹H-NMR.

(3) Glass transition temperature (Tg) was measured by differential scanning colorimetry method (DSC method).

(4) Adhesion Test

Peeling strength between internal insulating layer and upper insulating layer of the circuit board was determined by 90 degree peeling test in accordance with JIS C6481.

(5) Patternability Test

Wiring pattern of 100 wires was formed with wire width of 30 μm and wire separation of 30 μm, and evaluated as “A” when there was no disturbance in the shape of 100 wires, “B” when there was a disturbance in the shape but no defect, and “D” when there were defects.

### EXAMPLE 1

8-ethylidene-tetracyclo [4.4.0.1^{2, 5}.1^{7, 10}]-dodeca-3-ene was subjected to ring-opening polymerization followed by hydrogenation reaction Hydrogenated polymer with number average molecular weight (Mn)=31,200, weight average molecular weight (Mw)=55,800, Tg=about 155° C. was obtained. Hydrogenation ratio of the obtained polymer was 99% or more.

28 parts of the obtained polymer, 10 parts of maleic anhydride, and 3 parts of dicumylperoxide were dissolved in 130 parts of t-butylbenzene, and reaction was performed at 140° C. for 6 hours. Obtained solution of the reaction product was poured into 300 parts of methanol, thereby coagulating the reaction product to obtain a maleic acid denaturated hydrogenated polymer. This denaturated hydrogenated polymer was vacuum-dried at 100° C. for 20 hours. This denaturated hydrogenated polymer had molecular weight Mn=33,200, Mw=68,300, and Tg=170° C. Maleic acid content was 25 mol %.

100 parts of above described denaturated hydrogenated polymer, 50 parts of brominated bisphenol A-type epoxy resin (“Araldite” (trademark) AER 8049: manufactured by Asahi Chiba Co.), 0.1 part of setting accelerator (1-benzyl-2-phenylimidazole), and 30 parts of liquid epoxy compound (“Shell Block” (trademark): manufactured by Yuka Shell Epoxy Co.) were dissolved in a mixed solvent consisting of 135 parts of xylene and 90 parts of cyclopentanone to obtain a varnish.

The varnish was filtered with a Teflon micro-filter with pore diameter of 3 μm, and was applied using a die coater to a polyethylene naphthalate film (carrier film) of 300 mm square and 75 μm in thickness, and then was dried at 120° C. for 210 seconds in a nitrogen oven to obtain dry film of 35 μm in resin thickness with a carrier film.

Conductor wiring layers with wire width and wire separation of 75 μm and with thickness of wiring layer of 18 μm, and plated through-holes of 0.2 mm in diameter, were formed on a core substrate of 0.8 mm in thickness. The aforementioned dry films with a carrier film were superimposed onto both surfaces of the core substrate with the resin surfaces facing inward, and using a vacuum laminator at reduced atmospheric pressure of 1 mmHg, a laminated board was obtained by pressing under heat and pressure at temperature of 150° C. and pressure of 5 Kg/cm² for 30 minutes. The obtained laminated board was removed out of the laminator, and after only the polyethylene naphthalate films were separated, the laminated board was heated in a nitrogen oven at 180° C. for 60 minutes for setting the resin to form electrically insulating layers,

A UV-YAG laser was used to form via-holes of 30 μm in diameter for connection between layers in the insulating layer portion of the obtained laminated board. Then, after above laminated board was washed with water and dried, it was exposed to 1000 W argon plasma for 10 minutes.

Next, the laminated board was subjected to copper sputtering treatment to form copper thin film of 0.1 μm in thickness on wall surface of the via-holes and on the entire surface of the laminated board.

Then, a commercially available photosensitive dry film was adhered to the surface of the laminated board by pressing under heat and pressure, and a mask with a predetermined pattern was brought into close contact with the dry film, and after exposure to light, the film was developed to obtain a resist pattern. Then, electrolytic copper plating was performed on the portion where no resist was formed to form an electrolytic copper plating film of 18 μm in thickness. Then, the resist pattern was separated and removed with a releasing agent, and by removing the sputtered copper thin film that had been hidden under the resist with a mixed solution of copper (II) chloride and hydrochloric acid to form the wiring pattern. Finally, an annealing treatment was performed at 170° C. for 30 minutes to obtain a circuit board.

A solution for pre-treatment of the conductive layer was obtained by dissolving 0.1 part of 2-dibutylamino-4,6-dimercapto-S-triazine in 100 parts of isopropyl alcohol. The circuit board obtained as described above was soaked in the solution for pre-treatment of the conductive layer for 1 minute, and then dried at 90° C. for 15 minutes.

The circuit board treated in this manner was again used as aforementioned core substrate, and an electrically insulating layer and a conductive layer were repeatedly formed as described above so that a multilayer circuit board having in total 6 layers on both surfaces was obtained. The result of an evaluation is shown in Table 1.

### COMPARATIVE EXAMPLE

A multilayer circuit was obtained in the same manner as in Example 1 except that the copper sputtering treatment in Example 1 was not performed. The result of evaluation is shown in Table 1.

### EXAMPLE 2˜4

A multilayer circuit was obtained in the same manner as in Example 1 except that thickness of sputtered copper film formed by the copper sputtering treatment were 0.3, 0.5 and 0.7 μm, respectively. The result of evaluation is shown in Table 1.

### EXAMPLE 5

A multilayer-circuit was obtained in the same manner as in Example 2 except that argon plasma treatment in Example 2 was performed with power of 1500 W. The result of evaluation is shown in Table 1.

### EXAMPLE 6

A multilayer circuit was obtained in the same manner as in Example 2 except that the copper sputtering treatment in Example 2 was performed to obtain a sputtered copper thin film of 0.15 μm in thickness, and the copper sputtering treatment was again performed thereon to obtain a sputtered copper thin film of 0.15 μm in thickness resulting in the copper thin film of 0.3 μm in total thickness. The result of evaluation is shown in Table 1.

### EXAMPLE 7

A multilayer circuit was obtained in the same manner as in Example 2 except that, prior to argon plasma treatment, the laminated board was soaked for about 10 minutes in an aqueous solution at 80° C. in which a concentration of permanganic acid was adjusted to 0.3 mol/l and a concentration of caustic soda was adjusted to 3.0 mol/l. The result of evaluation is shown in Table 1.

TABLE 1

| | | | Copper | Electrolytic | Adhesion | |
|---|---|---|---|---|---|---|
| | Permanganic | | sputtering | plating | peeling | |
| | acid | Plasma | thickness | thickness | strength | |
| | treatment | treatment | (i) | (i) | (gf/cm) | Patternability |
| Comparative | Not performed | Not | — | 18 | * | D |
| example | | performed | | | | |
| Example 1 | Not performed | 1000 W | 0.1 | 18 | 5 | A |
| 2 | Not performed | 1000 W | 0.3 | 18 | 16 | A |
| 3 | Not performed | 1000 W | 0.5 | 18 | 52 | A |
| 4 | Not performed | 1000 W | 0.7 | 18 | 41 | A |
| 5 | Not performed | 1500 W | 0.3 | 18 | 37 | A |
| 6 | Not performed | 1000 W | 0.15 + 0.15 | 18 | 45 | A |
| 7 | Performed | 1000 W | 0.3 | 18 | 110 | A |

*too small to be measured.

It can be seen from Table 1 that adhesion strength is increased if plasma pre-treatment is performed and copper sputtering treatment is performed. It can also be seen that adhesion strength is further increased when copper sputtering treatment is repeated plural times. As can be seen from the Table, adhesion strength can be particularly increased if, prior to copper sputtering treatment, the laminated board is brought into contact with a permanganic acid compound, and further brought into contact with a plasma.

### INDUSTRIAL APPLICABILITY

According to the manufacturing method of the present invention, a multilayer circuit board which exhibits high adhesion between an electrically insulating layer and conductive layer, and which has excellent patternability can be easily obtained. The multilayer circuit board of the present invention can be used as a printed circuit board for packaging a semiconductor device such as CPU or a memory, or other package components in an electronic apparatus such as a computer or a mobile telephone. In particular, a multilayer circuit board having fine wirings is especially suitable as a high density printed circuit board to be used conveniently as a circuit board of a portable terminal used in high speed computers and in a high frequency range.

1. A method for manufacturing a multilayer circuit board comprising the steps of bringing the surface of an electrically insulating layer produced by setting a setting resin composition containing an alicyclic olefin polymer or an aromatic polyether polymer into contact with a permanganic acid compound or a plasma, and then dry-plating the surface.

2. A method for manufacturing a multilayer circuit board according to claim 1, further comprising the step of annealing after plating.

3. A method for manufacturing a multilayer circuit board according to claim 1, wherein the setting resin composition contains an alicyclic olefin polymer selected from the group consisting of a ring-opening polymer of norbornene type monomers or its hydride, addition polymer of norbornene type monomers, addition polymer of norbornene type monomers and vinyl compounds, and aromatic olefin polymer having hydrogenated aromatic ring.

4. A method for manufacturing a multilayer circuit board comprising the steps of dry-plating the surface of an electrically insulating layer produced by setting a setting resin composition containing an alicyclic olefin polymer or an aromatic polyether polymer, and then wet- or dry-plating the surface.

5. A method for manufacturing a multilayer circuit board according to claim 4, further comprising the step of annealing after plating.

6. A method for manufacturing a multilayer circuit board according to claim 4, wherein the setting resin composition contains an alicyclic olefin polymer selected from the group consisting of a ring-opening polymer of norbornene type monomers or its hydride, addition polymer of norbornene type monomers, addition polymer of norbornene type monomers and vinyl compounds, and an aromatic olefin polymer having a hydrogenated aromatic-ring.

7. A method for manufacturing a multilayer circuit board comprising the steps of dry-plating several times the surface of an electrically insulating layer produced by setting a setting resin composition containing an alicyclic olefin polymer or an aromatic polyether polymer, and then wet-plating the surface.

8. A method for manufacturing a multilayer circuit board according to claim 7, further comprising the step of annealing after plating.

9. A method for manufacturing a multilayer circuit board according to claim 7, wherein the setting resin composition contains an alicyclic olefin polymer selected from the group consisting of a ring-opening polymer of norbornene type monomers or its hydride, addition polymer of norbornene type monomers, addition polymer of norbornene type monomers and vinyl compounds, and aromatic olefin polymer having hydrogenated aromatic ring.

10. A method for manufacturing a multilayer circuit board according to claim 1, further comprising the step of wet- or dry-plating the surface, after the dry-plating step.

11. A method for manufacturing a multilayer circuit board according to claim 10, further comprising the step of annealing after plating.

12. A method for manufacturing a multilayer circuit board according to claim 10, wherein the setting resin composition contains an alicyclic olefin polymer selected from the group consisting of a ring-opening polymer of norbornene type monomers or its hydride, addition ploymer of norbornene type monomers, addition polymer of norbornene type monomers and vinyl compounds, and aromatic olefin polymer having hydrogenated aromatic ring.

13. A method for manufacturing a multilayer circuit board according to claim 1, wherein dry-plating is repeated several times, and then wet-plating is performed on the surface.

14. A method for manufacturing a multilayer circuit board according to claim 13, further comprising the step of annealing after plating.

15. A method for manufacturing a multilayer circuit board according to claim 13, wherein the setting resin composition contains an alicyclic olefin polymer selected from the group consisting of a ring-opening polymer of norbornene type monomers or its hydride, addition polymer of norbornene type monomers, addition polymer of norbornene type monomers and vinyl compounds, and aromatic olefin polymer having hydrogenated aromatic ring.

16. A method for manufacturing a multilayer circuit board according to claim 1, wherein the alicyclic olefin polymer has polar groups.

17. A method for manufacturing a multilayer circuit board according to claim 4, wherein the alicyclic olefin polymer has polar groups.

18. A method for manufacturing a multilayer circuit board according to claim 7, wherein the alicyclic olefin polymer has polar groups.
